(19) United States
(12) Patent Application Publication
(10) Pub. No.: US 2002/0194273 A1
(43) Pub. Date: Dec. 19, 2002

(54) Tracking system and method

(76) Inventors: Richard William Geibel, Cincinnati, OH (US); Karl Stephen Fessenden, Wilder, KY (US); Eric Scott Huron, West Chester, OH (US); Chunilal Kerai, Cardiff, WLS (US); Neil Walbeof, Gwent, WLS (US); Jeffrey Paul Griffiths, Mid-Glam, WLS (US)

Correspondence Address: BARBARA JOAN HAUSHALTER, LAW OFFICE, 228 BENT PINES CT., BELLEFONTAINE, OH, 43311, US

(21) Appl. No.: 09/884,509

(22) Filed: Jun. 15, 2001

(51) Int. Cl. G06F 15/16; G06F 15/173

(52) U.S. Cl. 709/204; 709/224

(57) ABSTRACT

An internet-based system and method are provided for tracking an engineering or development program from concept to production. The tracking system takes inputs from new engineering or development requests and can also take inputs from separate databases, such as a repair needs database. The new engineering or development request can be submitted by a web link from an existing or created Internet website, or from another source, by a system user. The tracking system can automatically create and update a tracking indicator, accessible by an Internet web link or other means. The tracking system can automatically prompt other internal functions or required inputs when certain key milestones are reached.

### BACKGROUND OF THE INVENTION

The present invention relates to a system to track engineering or development programs from concept to production.

Currently, engineering or development programs are tracked in individual, unconnected databases, using spreadsheets or other tracking methods. There is no existing linkage means for showing all active development programs at multiple facilities, such as various global facilities for a global corporation. Furthermore, there is no existing linkage between the time when engineering procedures are issued and the time when the manufacturing facilities are equipped and ready to perform the procedures. The lack of an integrated tracking and communication tool can result in miscommunications regarding procedure readiness. This, in turn, can lead to customer dissatisfaction and lost revenue opportunities.

It would be desirable to provide an electronic database for tracking current engineering development programs within a group.

### BRIEF SUMMARY OF THE INVENTION

A system is proposed for tracking engineering or development programs from concept to production. Without an integrated system, there is no way to automatically track the progress of engineering or development efforts from multiple sources, and no way to automatically prompt other internal functions of a required action, such as selecting a production source and initiating building of production tooling. The tracking system herein automatically tracks the progress of engineering or development efforts from one or multiple locations and/or multiple sources, even when distanced geographically, and is capable of automatically prompting internal functions of associated required actions when a procedure has been issued.

Accordingly, the present invention provides a tracking system that takes inputs from new engineering or development requests and from a separate database, such as a repair needs database. An exemplary repair needs database is disclosed and claimed in commonly owned, co-pending patent application Ser. No. ______ (Attorney Docket No. 13DV13824), entitled Web Enabled System For Component Hardware Repair Collaboration and Material Replacement. The new engineering or development request can be submitted by a web link from an existing or created Internet website, or from another source. The tracking system can automatically create and update a tracking indicator, accessible by an Internet web link or other means. The tracking system can automatically prompt other internal functions or required inputs when certain key milestones are reached.

### BRIEF DESCRIPTION OF THE DRAWING

FIG. 1 is a schematic block diagram illustrating a tracking system.

### DETAILED DESCRIPTION OF THE INVENTION

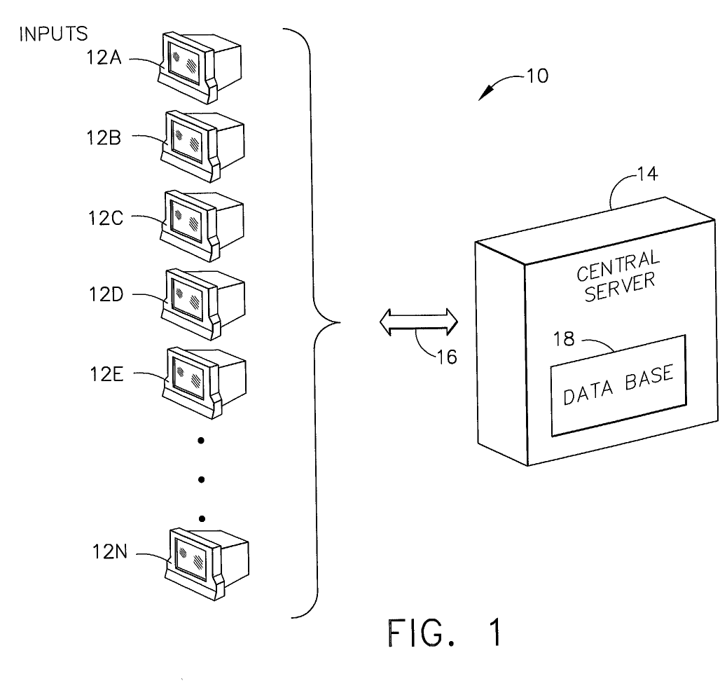

Referring to FIG. 1, there is a schematic block diagram 10 illustrating a database arrangement 10 for storing accessible details on component hardware and repair needs related thereto for which solutions are sought and programs are initiated. For exemplary purposes only, system 10 is described as a repair tracking system. It will be obvious to those skilled in the art that the tracking system concept of the present invention can be applied to a multitude of engineering or development type systems without departing from the scope of the invention. System 10 is configured to provide an online interface (website) whereby customers and repair shops can track repair programs, submit repair efforts, and obtain repair availability information. The system 10 can store and download to a user interface textual and digital images of the parts and related data.

The system 10 comprises one or more user computers 12A-12N that are representative of separate listings for each collaborator in the system. Each collaborative partner external to the entity owning the database will typically have access only to its own listing and to the centralized data, not direct access to each of the other collaborative partner listings. Collaborators within the owning entity or company would typically have access to all of the available data.

The listings can be updated online, as the collaborative partner develops and gains approval for new component repair solutions. The collaborative partners 12A-12N are connectable to the central server 14 through any suitable interface such as dial-in-connections, cable modems, Internet access, special high-speed ISDN lines and networks such as local area networks (LANs) or wide area networks (WANs). Alternatively, the collaborative partners can be any client system capable of interconnecting to the Internet including a web-based phone or other web-based connectable equipment.

The structure of the system 10 allows for each collaborative partner 12A-12N to submit repair developments to the central server 14. The separate collaborative partners each benefit from the expanded sources for data and the automatic prompting of internal functions of a required action, such as choosing a production source, initiating building of production tooling, and beginning production qualification efforts.

The server 14 is configured with a database 18 of engineering and development needs of the multiple users, engineering and development requests, and engineering and development procedures. The server 14 is further configured with a user interface 16 to allow a user to input information into the database 18 for upload to the server 14, including engineering and development programs of the user and engineering and development requests of the user. The user interface 16 also allows a user to download information from the database 18, including engineering and development procedures responsive to engineering and development requests. The interface 16 can be provided by any suitable means, such as by web pages that can be transmitted from the database to the user via a website.

In a preferred embodiment, the central server 14 receives data not only from each collaborative partner, including customers and repair shops, but can accept program initiation information inputs and repair needs inputs. The inputs can be manually input or automatically input, such as from a wizard linked to another database. The central server 14 can provide real time information on component repair developments, to show all active repair development programs at multiple sites, and the stage of each program. The system 10 can therefore provide a link between when the repair procedures are issued and when the manufacturing facilities are equipped and ready to perform the repairs. This can reduce or eliminate miscommunications regarding repair readiness.

Continuing with FIG. 1, the system 10 can comprise any kind of digital communication network or combination of digital communication networks. For example, the network can include a web browser, local area network (LAN), wide area network (WAN), World Wide Web, or any combination of these networks. Likewise, the user computers 12A-12N and the central server 14 can be of any form so long as the repair development program information can be communicated between a user computer and the central server 14.

The system 10 allows each of the collaborative partners 12A-12N to interface with the central server 14, conveying repair development program information and receiving repair readiness information. The interface includes an input portion and an output portion. The input portion of the interface is used to convey information from the collaborative partner computer to the central server 14. Typically, the input information is generated by the user's actuation of an input peripheral, such as a mouse or a keyboard. The output portion conveys information from the central server 14 to the collaborative partner computer and is typically displayed on the monitor of the collaborative partner computer. However, the output portion is capable of being displayed on other output peripherals, like printers.

In one embodiment of the system of FIG. 1, the interface is provided by web pages that can be transmitted by the central server 14 to each of the collaborative partner listings 12A-12N, typically upon request for the information by the collaborative partner. Therefore, while each collaborative partner may receive identical information, it is more typical for each collaborative partner to receive information relevant to the request for the particular repair development program information made by that particular collaborative partner.

Although the configuration described herein refers to a website being geographically and physically separated from each user link 12A-12N, this does not preclude integrating the website data and information into each of the user sites 12A-12N to create a stand-alone system. In such a case, it is feasible to use a network to update the information resident in each of the computers 12A-12N. It is also feasible to download the website information and data to the user computer 12A-12N each time a repair development program is initiated.

Continuing with FIG. 1, during communication between the central server 14 and the user sites 12A-12N, all repair developments are deposited at the central server 14. The database 18 also provides the ability to profile repair requirements of world wide fleets, track key repair programs, summarize customer needs, track repair cycle times, and access repair status information.

Communication between the central server 14 and the user links 12A-12N also categorizes the repairs each user is capable of handling, and saves this collaborative partner repair listing data. The central server 14 can maintain a list of locally developed repair capabilities for each of the collaborative partners. The list can include repair developments in progress as well as a link between when repair procedures are issued and when the manufacturing facility is equipped and ready to perform the repairs. When a user provides information on its own repair development capabilities, the information is saved at the central server 14.

Since component recovery is typically less expensive than component replacement, it is beneficial to all users to share their repair data. However, the tracking system of the present invention is useful in tracking a variety of engineering and development programs. The central database streamlines procedure dissemination, and can speed up production implementation. The business application developed herein allows users to collaborate online with geographically and/or physically remote users to track engineering and development programs. The central server 14 can be used to offer development information and services between users and to bring separate users together in any manufacturing or service industry. The separate users can collaborate remotely to track engineering or development programs, to increase knowledge, to increase speed of development program initiation, and to decrease costs.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for tracking engineering and development programs comprising:
a server configured with a database of engineering and development needs of the multiple users, engineering and development requests, and engineering and development procedures, said server capable of receiving information input from a user into the database for upload to said server including engineering and development programs of said user and engineering and development requests of said user, and allowing a user to download information from the database including engineering and development procedures responsive to engineering and development requests;
at least one computer; and
an interface between the at least one computer and the server.

2. A system as claimed in claim 1 wherein access to said server is configured to be secured by user password.

3. A system as claimed in claim 1 wherein the engineering and development programs are tracked from initial development to qualification.

4. A system as claimed in claim 1 wherein said user comprises multiple users.

5. A system as claimed in claim 4 wherein the database is owned by an owner entity.

6. A system as claimed in claim 5 wherein the multiple users comprise users internal to the owner entity and users external to the owner entity.

7. A system as claimed in claim 1 wherein the interface is provided by web pages that can be transmitted from the database to the user.

8. A system as claimed in claim 1 wherein the engineering and development programs comprise a repair development program.

9. A system as claimed in claim 1 wherein said server is configured to store and download text and digital images.

10. A method for tracking engineering and development programs by internal users and external users using a system which includes a server and at least one client system, the method comprising the steps of:
uploading user information to the server;
downloading from the server, web pages configured to direct internal and external users to a database within the server, the database configured with engineering and development program information;
uploading user selections input into the web pages to the server; and
downloading from the server engineering and development procedures responsive to engineering and development requests.

11. A method as claimed in claim 10 further comprising the step of configuring the server to be secured by user password.

12. A method as claimed in claim 10 wherein the engineering and development programs are tracked from initial development to qualification.

13. A method as claimed in claim 10 wherein the engineering and development programs comprise a repair development program.

14. A method as claimed in claim 10 further comprising the step of configuring the server to receive, categorize, and store user repair capabilities based on information provided by the internal and external users.

15. A method as claimed in claim 10 further comprising the step of configuring the server to receive, profile, track and store program status information and user needs.

16. A method as claimed in claim 10 further comprising the step of configuring the server to store and download text and digital images.
